(19) United States
(12) Patent Application Publication
(10) Pub. No.: US 2009/0319408 A1
(43) Pub. Date: Dec. 24, 2009

(54) PROVISON APPLICATION SYSTEM AND METHOD

(76) Inventors: Michael Callahan, Marblehead, MA (US); Marc N. Teal, Dracut, MA (US); Brian Madden, Plymouth, MA (US)

Correspondence Address: HOLLAND & KNIGHT LLP, 10 ST. JAMES AVENUE, BOSTON, MA, 02116-3889, US

(21) Appl. No.: 12/487,985

(22) Filed: Jun. 19, 2009

Related U.S. Application Data
(60) Provisional application No. 61/073,969, filed on Jun. 19, 2008.
(60) Provisional application No. 61/073,960, filed on Jun. 19, 2008.
(60) Provisional application No. 61/073,957, filed on Jun. 19, 2008.

(51) Int. Cl. G06Q 40/00; G06Q 10/00; G06F 17/30; G06Q 30/00; G06Q 50/00

(52) U.S. Cl. 705/34; 705/30; 707/5; 707/E17.014; 707/E17.044

(57) ABSTRACT

A system, computer-implemented method, and a computer program product for defining one or more payment distribution priorities associated with one or more rental properties. Rental property performance data is received from a rental property datastore. The one or more payment distribution priorities are applied to the rental property performance data to generate payment distribution data. A payment distribution report is generated.

### RELATED APPLICATION(S)

This application claims the benefit of the following provisional patent applications, each of which is herein incorporated by reference in their entirety: U.S. Ser. No. 61/073,969, filed on 19 Jun. 2008; U.S. Ser. No. 61/073,960, filed on 19 Jun. 2008; and U.S. Ser. No. 61/073,957, filed on 19 Jun. 2008.

### TECHNICAL FIELD

This disclosure relates to the application of contract provision data and, more particularly, to the application of contract provision data related to rental properties.

### BACKGROUND

Databases are often utilized in enterprise environments to store and organize data. An example of such a database is a database that defines rental property data. Oftentimes, users may be involved in the distribution of funds associated with the rental properties defined by such rental property data. Further, it may be commonplace for the distribution of those funds to be distributed pursuant to provisions of contracts associated with the rental properties.

It may often be useful for a user to utilize such rental property databases to define those provisions for application of them based on an associated priority of distribution.

### SUMMARY OF DISCLOSURE

In a first implementation, a provision application system includes a rental property datastore configured to define one or more payment distribution priorities associated with one or more rental properties. A rental property performance process is configured to receive rental property performance data from the rental property datastore. A rules engine applies the one or more payment distribution priorities to the rental property performance data to generate payment distribution data. A payment distribution process is configured to generate a payment distribution report.

One or more of the following features may be included. The rental property datastore may be a rental property database. The rental property performance data may include audit data. Applying the one or more payment distribution priorities to the rental property performance data may include calculating an available cash flow from the audit data. An override process may be configured to enable the user to override the available cash flow. The payment distribution report may be an annual invoice. A priority definition process may allow the user to define the one or more payment distribution priorities.

In another implementation, a computer-implemented method includes defining one or more payment distribution priorities associated with one or more rental properties. Rental property performance data is received from a rental property datastore. The one or more payment distribution priorities are applied to the rental property performance data to generate payment distribution data. A payment distribution report is generated.

One or more of the following features may be included. The rental property datastore may be a rental property database. The rental property performance data may include audit data. Applying the one or more payment distribution priorities to the rental property performance data may include calculating an available cash flow from the audit data. An override process may be configured to enable the user to override the available cash flow. The payment distribution report may be an annual invoice. The user may be allowed to define the one or more payment distribution priorities.

In yet another implementation, a computer program product resides on a computer readable medium that has a plurality of instructions stored on it. When executed by a processor, the plurality of instructions cause the processor to perform operations including defining one or more payment distribution priorities associated with one or more rental properties. Rental property performance data is received from a rental property datastore. The one or more payment distribution priorities are applied to the rental property performance data to generate payment distribution data. A payment distribution report is generated.

One or more of the following features may be included. The rental property datastore may be a rental property database. The rental property performance data may include audit data. Applying the one or more payment distribution priorities to the rental property performance data may include calculating an available cash flow from the audit data. Instructions may be included for enabling the user to override the available cash flow. The payment distribution report may be an annual invoice. Instructions may be included to allow the user to define the one or more payment distribution priorities.

The details of one or more implementations are set forth in the accompanying drawings and the description below. Other features and advantages will become apparent from the description, the drawings, and the claims.

### BRIEF DESCRIPTION OF THE DRAWINGS

FIG. 1 is a diagrammatic view of a provision application process coupled to a distributed computing network;

FIG. 2 is a flowchart of the provision application process of FIG. 1;

FIG. 3 is a diagrammatic view of a priority definition process of the provision application process of FIG. 1; and

FIG. 4 is a diagrammatic view of a payment distribution report of the provision application process of FIG. 1.

Like reference symbols in the various drawings indicate like elements.

### DETAILED DESCRIPTION OF THE PREFERRED EMBODIMENTS

### System Overview

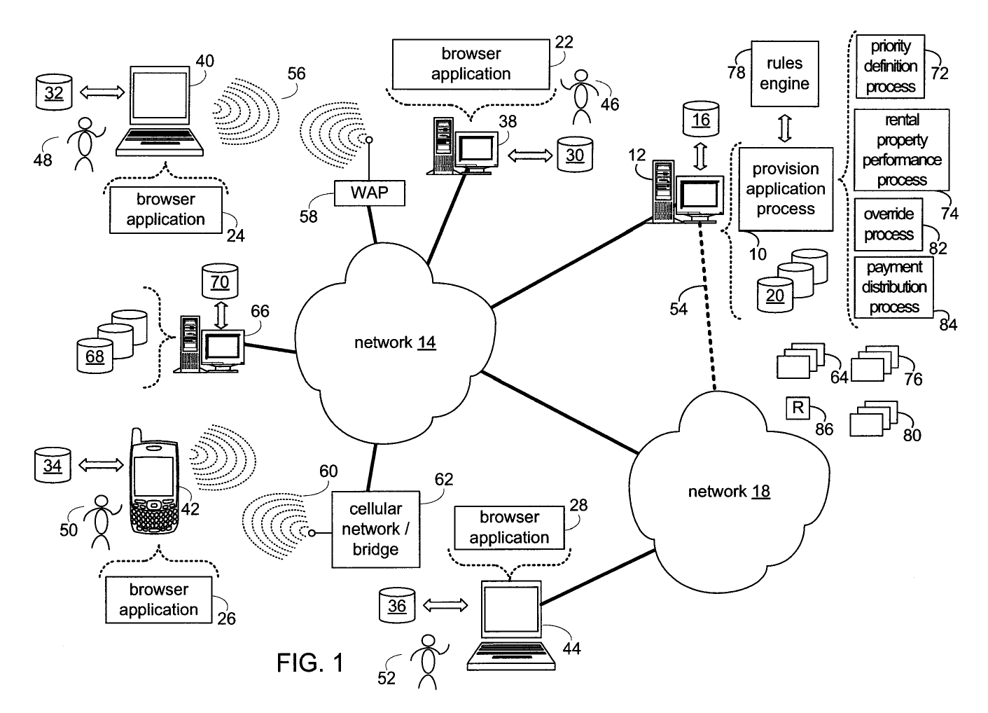

Referring to FIG. 1, there is shown provision application process 10 that may reside on and may be executed by server computer 12, which may be connected to network 14 (e.g., the Internet or a local area network). Examples of server computer 12 may include, but are not limited to: a personal computer, a server computer, a series of server computers, a mini computer, and a mainframe computer. Server computer 12 may be a web server (or a series of servers) running a network operating system, examples of which may include but are not limited to: Microsoft Windows XP Server™; Novell Netware™; or Redhat Linux™, for example.

As will be discussed below in greater detail, provision application process 10 may include, and/or interact with, a rental property datastore that may be configured to define one or more payment distribution priorities associated with one or more rental properties. Provision application process 10 may include a rental property performance process that may be configured to receive rental property performance data from the rental property datastore. Provision application process 10 may also include a rules engine that may apply the one or more payment distribution priorities to the rental property performance data to generate payment distribution data. Additionally, provision application process 10 may include a payment distribution process that may be configured to generate a payment distribution report.

The instruction sets and subroutines of provision application process 10, which may be stored on storage device 16 coupled to server computer 12, may be executed by one or more processors (not shown) and one or more memory architectures (not shown) incorporated into server computer 12. Storage device 16 may include but is not limited to: a hard disk drive; a tape drive; an optical drive; a RAID array; a random access memory (RAM); and a read-only memory (ROM).

Server computer 12 may execute a web server application, examples of which may include but are not limited to: IBM WebSphere™, Microsoft IIS™, Novell Webserver™, or Apache Webserver™, that allows for HTTP (i.e., HyperText Transfer Protocol) access to server computer 12 via network 14. Network 14 may be connected to one or more secondary networks (e.g., network 18), examples of which may include but are not limited to: a local area network; a wide area network; or an intranet, for example.

Server computer 12 may execute rental property datastore 20, examples of which may include but are not limited to databases produced by Microsoft and Oracle. Rental property datastore 20 may allow for an organization to store, manage, and access data stored within the datastore. One non-limiting example of such data may include but is not limited to data concerning rental properties. For example, database records may be generated that identify various rental properties and information concerning such rental properties (e.g., the identity of the owner of the rental property, the purchase price of the rental property, the tax liability of the rental property, the income generated by the rental property, and the provisions of the contract associated with the rental property that describe the priorities for distributing payments, for example). Rental property datastore 20 may be a stand-alone application that interfaces with provision application process 10 and/or an applet/application that is executed within provision application process 10.

The instruction sets and subroutines of rental property datastore 20, which may be stored on storage device 16 coupled to server computer 12, may be executed by one or more processors (not shown) and one or more memory architectures (not shown) incorporated into server computer 12.

One or more client applications (e.g., which may include one or more custom applications, and/or one or more general purpose applications, such as browser applications 22, 24, 26, 28) may access and/or interact with provision application process 10 and/or review data store 20. The instruction sets and subroutines of browser applications 22, 24, 26, 28, which may be stored on storage devices 30, 32, 34, 36 (respectively) coupled to client electronic devices 38, 40, 42, 44 (respectively), may be executed by one or more processors (not shown) and one or more memory architectures (not shown) incorporated into client electronic devices 38, 40, 42, 44 (respectively). Storage devices 30, 32, 34, 36 may include but are not limited to: hard disk drives; tape drives; optical drives; RAID arrays; random access memories (RAM); read-only memories (ROM), compact flash (CF) storage devices, secure digital (SD) storage devices, and memory stick storage devices. Examples of client electronic devices 38, 40, 42, 44 may include, but are not limited to, personal computer 38, laptop computer 40, personal digital assistant 42, notebook computer 44, a server (not shown), a data-enabled, cellular telephone (not shown), and a dedicated network device (not shown). Using browser applications 22, 24, 26, 28, users 46, 48, 50, 52 (respectively) may access provision application process 10 to generate payment distribution reports.

Users 46, 48, 50, 52 may access provision application process 10 directly through the device on which the browsing application (e.g., browsing applications 22, 24, 26, 28) is executed, namely client electronic devices 38, 40, 42, 44, for example. Users 46, 48, 50, 52 may access provision application process 10 directly through network 14 or through secondary network 18. Further, server computer 12 (i.e., the computer that executes provision application process 10) may be connected to network 14 through secondary network 18, as illustrated with link line 54 (shown in phantom).

The various client electronic devices may be directly or indirectly coupled to network 14 (or network 18). For example, personal computer 38 is shown directly coupled to network 14 via a hardwired network connection. Further, notebook computer 44 is shown directly coupled to network 18 via a hardwired network connection. Laptop computer 40 is shown wirelessly coupled to network 14 via wireless communication channel 56 established between laptop computer 40 and wireless access point (i.e., WAP) 58, which is shown directly coupled to network 14. WAP 58 may be, for example, an IEEE 802.11a, 802.11b, 802.11g, Wi-Fi, and/or Bluetooth device that is capable of establishing wireless communication channel 56 between laptop computer 40 and WAP 58. Personal digital assistant 42 is shown wirelessly coupled to network 14 via wireless communication channel 60 established between personal digital assistant 42 and cellular network/bridge 62, which is shown directly coupled to network 14.

As is known in the art, all of the IEEE 802.11x specifications may use Ethernet protocol and carrier sense multiple access with collision avoidance (i.e., CSMA/CA) for path sharing. The various 802.11x specifications may use phase-shift keying (i.e., PSK) modulation or complementary code keying (i.e., CCK) modulation, for example. As is known in the art, Bluetooth is a telecommunications industry specification that allows e.g., mobile phones, computers, and personal digital assistants to be interconnected using a short-range wireless connection.

Client electronic devices 38, 40, 42, 44 may each execute an operating system, examples of which may include but are not limited to Microsoft Windows™, Microsoft Windows CE™, Redhat Linux™, or a custom operating system.

For the following discussion, browser application 22 is going to be described for illustrative purposes. However, this is not intended to be a limitation of this disclosure, as other browsing applications (e.g., browsing applications 24, 26, 28) may be equally utilized.

Assume for illustrative purposes that provision application process 10 includes rental property datastore 20 that defines a plurality of database records that identify various rental properties and information concerning payment provisions of the contracts associated with such rental properties (e.g., payment distribution priority data 64). Further, assume that server computer 66 may execute backend datastore 68 that may be coupled to provision application process 10 (e.g., via network 14 and/or network 18). Data may be extracted from backend datastore 68 and used to populate rental property datastore 20. As stated above, examples of backend datastore 68 may include but are not limited to databases produced by Microsoft and Oracle.

The instruction sets and subroutines of backend datastore 68, which may be stored on storage device 70 coupled to server computer 66, may be executed by one or more processors (not shown) and one or more memory architectures (not shown) incorporated into server computer 66.

While backend datastore 68 is shown to be a single datastore, this is for illustrative purposes only and is not intended to be a limitation of this disclosure, as other configurations are possible. For example, backend datastore 68 may include a plurality of individual datastores, examples of which may include but are not limited to an investor database, and a document management database. Additionally, while server computer 66 is shown to be a single server, this is for illustrative purposes only and is not intended to be a limitation of this disclosure, as other configurations are possible. For example, server computer 66 may include a plurality of individual server computers, examples of which may include but are not limited to an investor server computer, and a document management server computer.

### The Provision Application Process:

As stated above and as will be discussed below in greater detail, provision application process 10 may include, and/or may interact with, a rental property datastore that may be configured to define one or more payment distribution priorities associated with one or more rental properties. Provision application process 10 may include a rental property performance process that may be configured to receive rental property performance data from the rental property datastore. Further, provision application process 10 may include a rules engine that may apply the one or more payment distribution priorities to the rental property performance data to generate payment distribution data. Additionally, provision application process 10 may include a payment distribution process that may be configured to generate a payment distribution report.

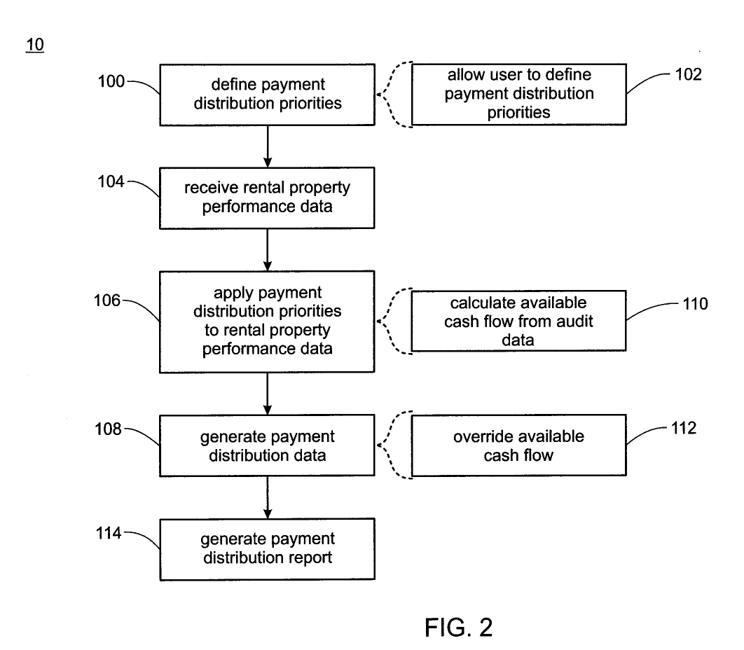

Referring also to FIG. 2, provision application process 10 may allow a user to define 100 payment distribution priority data 64 associated with a plurality of rental properties within rental property datastore 20. For example, user 46 may directly define 100 payment distribution priority data 64 associated with one or more rental properties within reporting datastore 20 via e.g., browser application 22 executed on personal computer 38. Additionally, payment distribution priority data 64 may include audit data (e.g., financial data relevant to the ownership, operation, and management of the rental properties).

Additionally/alternatively, user 46 may directly define 100 payment distribution priority data 64 associated with one or more rental properties within backend datastore 68 via e.g., browser application 22 executed on personal computer 38. At least a portion of payment distribution priority data 64 included within backend datastore 68 may be extracted from backend datastore 68 and may be used to populate rental property datastore 20 (which, as discussed above, may be coupled to backend datastore 68). Accordingly, an independent copy (or a portion thereof) of payment distribution priority data 64 included within backend datastore 68 may be maintained within rental property datastore 20. Therefore, provision application process 10 need not have access to backend datastore 68 and may only need access to rental property datastore 20. Further, as at least a portion of payment distribution priority data 64 included within backend datastore 68 may be extracted from backend datastore 68 and used to populate rental property datastore 20, the structure of backend datastore 68 need not be known/understood by user 46, as only the algorithm/process (not shown) used to extract data from backend datastore 68 and populate rental property datastore 20 needs to know/understand the structure of backend datastore 68.

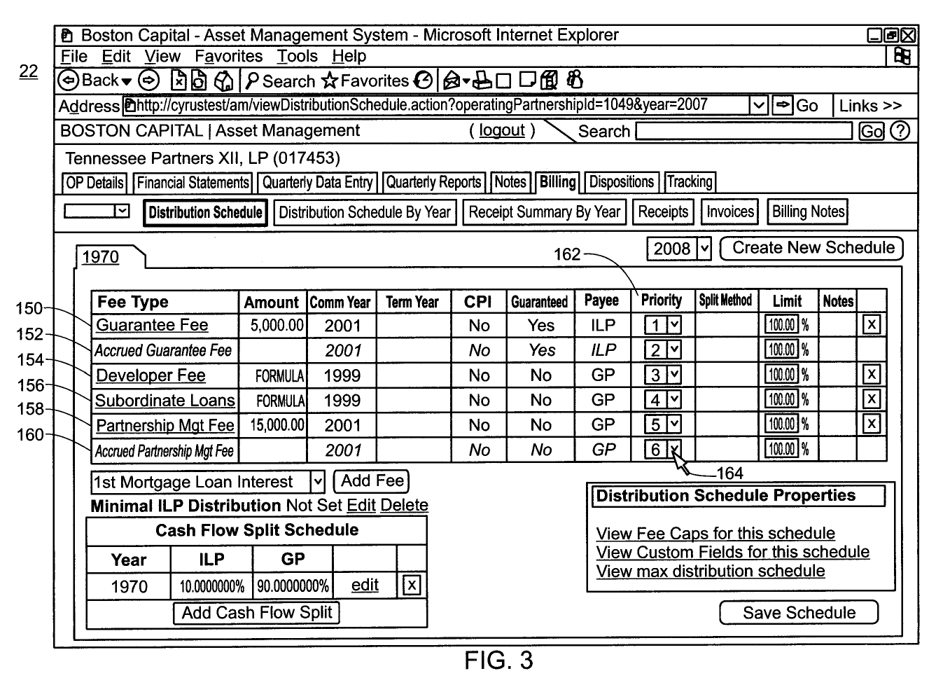

For example, and referring also to FIG. 3, suppose user 46 managed many rental properties and wanted to utilize provision application process 10 to define 100 payment distribution priority data 64 concerning various contract provisions associated with those rental properties. Distribution of revenue associated with one of the rental properties that user 46 manages may be governed by one or more contract provisions. Examples of such contract provisions may include payment of various fees including, but not limited to: guarantee fees (e.g., guarantee fee 150); accrued guarantee fees (e.g., accrued guarantee fee 152); developer fees (e.g., developer fee 154); subordinate loans (e.g., subordinate loan 156); partnership management fees (e.g., partnership management fee 158); and accrued partnership management fees (e.g., accrued partnership management fee 160). Further, the contract provisions may establish an order of priority for the payment of such fees. For example, the contract provisions may state that, e.g., guarantee fees (e.g., guarantee fee 150) are paid first, accrued guarantee fees (e.g., accrued guarantee fee 152) are paid second, and so forth.

As such, provision application process 10 may include a priority definition process (e.g., priority definition process 72) for allowing 102 the user (e.g., user 46) to define 100 one or more payment distribution priorities (e.g., payment distribution priority data 64). Illustratively, and continuing with the above-stated example, user 46 may utilize, e.g., browser application 22 to access priority definition process 72. As shown in FIG. 3, priority definition process 72 (via, e.g., browser application 22) may display the various fees of the contract provisions as well as provide a mechanism for defining the order in which such fees may be paid (e.g., priority column 162). Utilizing, e.g., on-screen pointer 164, priority definition process 72 (e.g., which may be included within and/or interact with, provision application process 10) may allow 102 user 46 to define 100 payment distribution priority data 64 (e.g., the order in which the various fees may be paid, which may be in accordance with the provisions of the contract associated with a particular rental property).

Additionally, provision application process 10 may include, and/or interact with, a rental property performance process (e.g., rental property performance process 74) that may be configured to receive 104 rental property performance data (e.g., rental property performance data 76) from a rental property datastore (e.g., rental property datastore 20). One example of rental property performance data 76 may include, but is not limited to, audited financial data associated with one or more rental properties.

Further, rental property performance data 76 may be received 104 directly or indirectly. For example, rental property performance data 76 may have been directly populated into, e.g., rental property datastore 20 by a user (e.g., user 46), or rental property performance data 76 may have been provided to, e.g., rental property datastore 20 from, e.g., a database maintained by a third party. Accordingly, rental property performance process 74 may receive 104 rental property performance data 76 from, e.g., rental property datastore 20, which may acquire such data in any number of manners known to one of skill in the art.

Additionally, provision application process 10 may include, and/or interact with, a rules engine (e.g., rules engine 78) that may apply 106 the one or more payment distribution priorities (e.g., payment distribution priority data 64) to the rental property performance data (e.g., rental property performance data 76) to generate 108 payment distribution data. As will be described in greater detail below, one example of payment distribution data (e.g., payment distribution data 80) may include, but is not limited to, a calculated fee based upon, e.g., the amount of available cash flow for a given rental property, the various fees associated with that rental property, and the order of priority associated with the payment of such fees.

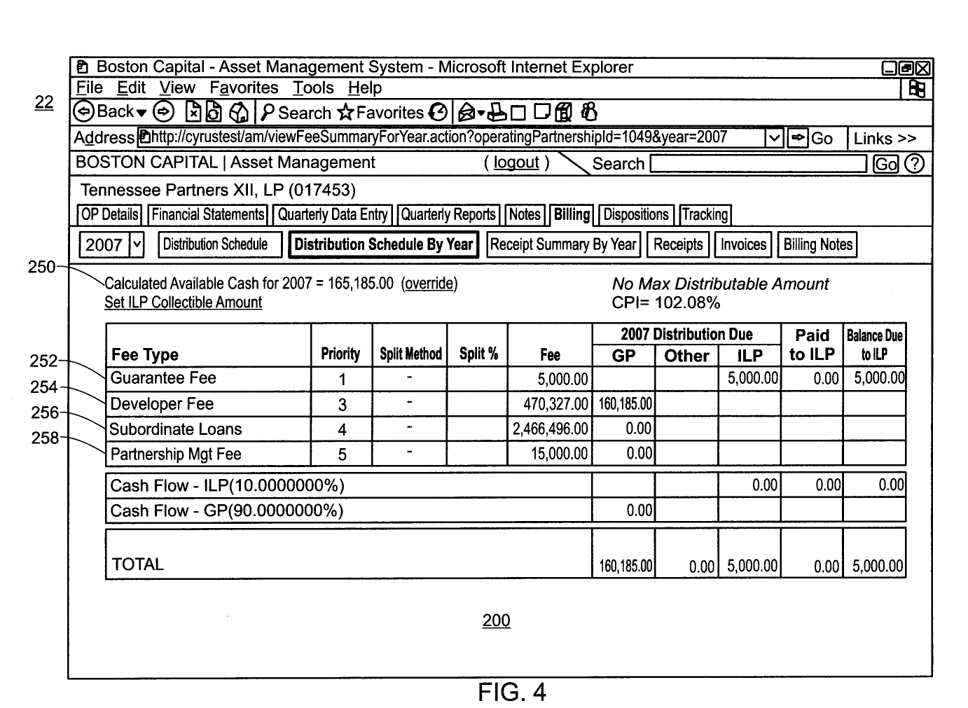

Further, and referring also to FIG. 4, rules engine 78 may apply 106 payment distribution priority data 64 to rental property performance data 76 by calculating 110 an available cash flow (e.g., available cash flow 250) from the audit data. For example, assume that, in 2007, an audit of a particular rental property revealed that it derived a cash flow of, e.g., $165,185.00. Rules engine 78 of provision application process 10 may then apply 106 the one or more payment distribution priorities (e.g., payment distribution priority data 64) to available cash flow 250 to generate 108 payment distribution data (e.g., payment distribution data 80).

Moreover, provision application process 10 may include, and/or interact with, an override process (e.g., override process 82) to enable a user to override 112 the available cash flow (e.g., available cash flow 250). For example, assume that, e.g., user 46 was aware of legitimate reasons that a portion of available cash flow 250 should not be distributed. Accordingly, override process 82 may enable user 46 to override 112 available cash flow 250 to reflect the amount of cash that may be legitimately distributed.

Additionally, provision application process 10 may include, and/or interact with, a payment distribution process (e.g., payment distribution process 84) that may be configured to generate 114 a payment distribution report (e.g., payment distribution report 86). One example of payment distribution report 86 may include, but is not limited to, an annual invoice (e.g., annual invoice 200). Illustratively, and as shown in FIG. 4, annual invoice 200 may display the allocation of available cash flow 250 to, e.g., guarantee fee 252, developer fee 254, subordinate loan fee 256, and partnership management fee 258.

Additionally, while provision application process 10 has been described from the perspective of generating 108 payment distribution reports for the purpose of distributing, e.g., available cash flows, this is not to be construed as a limitation of this disclosure, as other configurations are possible. For example, provision application process 10 may be utilized to apply payments (associated with a particular rental property) received pursuant to one or more payment distribution priorities. That is, upon receipt of a given payment concerning a particular rental property, provision application process 10 may apply portions of that payment to the various fees (e.g., guarantee fee 150, accrued guarantee fee 152, etc.) in the order in which such fees are prioritized.

A number of implementations have been described. Nevertheless, it will be understood that various modifications may be made. Accordingly, other implementations are within the scope of the following claims.

What is claimed is:

1. A provision application system comprising:
a rental property datastore configured to define one or more payment distribution priorities associated with one or more rental properties;
a rental property performance process configured to receive rental property performance data from the rental property datastore;
a rules engine for applying the one or more payment distribution priorities to the rental property performance data to generate payment distribution data; and
a payment distribution process configured to generate a payment distribution report.

2. The provision application system of claim 1 wherein the rental property datastore is a rental property database.

3. The provision application system of claim 1 wherein the rental property performance data includes audit data.

4. The provision application system of claim 3 wherein applying the one or more payment distribution priorities to the rental property performance data includes calculating an available cash flow from the audit data.

5. The provision application system of claim 4 further comprising:
an override process configured to enable the user to override the available cash flow.

6. The provision application system of claim 1 wherein the payment distribution report is an annual invoice.

7. The provision application system of claim 1 further comprising:
a priority definition process for allowing the user to define the one or more payment distribution priorities.

8. A computer-implemented method comprising:
defining one or more payment distribution priorities associated with one or more rental properties;
receiving rental property performance data from a rental property datastore;
applying the one or more payment distribution priorities to the rental property performance data to generate payment distribution data; and
generating a payment distribution report.

9. The computer-implemented method of claim 8 wherein the rental property datastore is a rental property database.

10. The computer-implemented method of claim 8 wherein the rental property performance data includes audit data.

11. The computer-implemented method of claim 10 wherein applying the one or more payment distribution priorities to the rental property performance data includes calculating an available cash flow from the audit data.

12. The computer-implemented method of claim 11 further comprising:
enabling the user to override the available cash flow.

13. The computer-implemented method of claim 8 wherein the payment distribution report is an annual invoice.

14. The computer-implemented method of claim 8 further comprising:
allowing the user to define the one or more payment distribution priorities.

15. A computer program product residing on a computer readable medium having a plurality of instructions stored thereon, which, when executed by a processor, cause the processor to perform operations comprising:
defining one or more payment distribution priorities associated with one or more rental properties;
receiving rental property performance data from a rental property datastore;
applying the one or more payment distribution priorities to the rental property performance data to generate payment distribution data; and
generating a payment distribution report.

16. The computer program product of claim 15 wherein the rental property datastore is a rental property database.

17. The computer program product of claim 15 wherein the rental property performance data includes audit data.

18. The computer program product of claim 17 wherein applying the one or more payment distribution priorities to the rental property performance data includes calculating an available cash flow from the audit data.

19. The computer program product of claim 18 further comprising instructions for:
enabling the user to override the available cash flow.

20. The computer program product of claim 15 wherein the payment distribution report is an annual invoice.

21. The computer program product of claim 15 further comprising instructions for:
allowing the user to define the one or more payment distribution priorities.
